(19) United States
(12) Patent Application Publication
(10) Pub. No.: US 2023/0267435 A1
(43) Pub. Date: Aug. 24, 2023

(54) DYNAMIC PRICE-MATCHING IN COMMERCIAL TRANSACTIONS

(71) Applicant: International Business Machines Corporation, Armonk, NY (US)

(72) Inventors: Christian Compton, Austin, TX (US); Jeremy R. Fox, Georgetown, TX (US); Su Liu, Austin, TX (US); Hamid Majdabadi, Ottawa (CA)

(21) Appl. No.: 17/652,291

(22) Filed: Feb. 24, 2022

(51) Int. Cl. G06Q 20/20; G06Q 30/02

(52) U.S. Cl. CPC G06Q 20/201; G06Q 30/0206; G06Q 20/202

(57) ABSTRACT

In an approach for automating and improving the process of price-matching a product at the point-of-sale terminal, a processor receives a price-matching claim for a product from a shopper. A processor determines whether the product is eligible to be price-matched by analyzing one or more details of the price-matching claim. Responsive to determining the product is eligible to be price-matched, a processor detects a lowest price of the product from the one or more details of the price-matching claim. A processor automatically adjusts a current price of the product to match the lowest price of the product detected at a point-of-sale terminal of a merchant according to a set of pre-defined price-matching policies.

### BACKGROUND OF THE INVENTION

The present invention relates generally to the field of data processing, and more particularly to dynamic price-matching in commercial transactions.

Price-matching is a practice where a merchant agrees to match the price of a product with a lower advertised price of a competitor, usually when the shopper presents evidence of the lower advertised price, and to sell the same product to the shopper for the lower advertised price. To remain competitive and to increase brand loyalty, large retailers offer to match the price of a product. Sometimes, those large retailers will even offer retroactive price-matching or even beat the lower advertised price. Because of today's hyper-competitive retail market and constant price shifting, a price-matching policy can be a key differentiator.

### SUMMARY

Aspects of an embodiment of the present invention disclose a method, computer program product, and computer system for automating and improving the process of price-matching a product at the point-of-sale terminal. A processor receives a price-matching claim for a product from a shopper. A processor determines whether the product is eligible to be price-matched by analyzing one or more details of the price-matching claim. Responsive to determining the product is eligible to be price-matched, a processor detects a lowest price of the product from the one or more details of the price-matching claim. A processor automatically adjusts a current price of the product to match the lowest price of the product detected at a point-of-sale terminal of a merchant according to a set of pre-defined price-matching policies.

In some aspects of an embodiment of the present invention, subsequent to automatically adjusting the current price of the product to match the lowest price of the product detected at the point-of-sale terminal of the merchant, a processor completes a transaction on the point-of-sale terminal of the merchant that includes the product. A processors updates a learning module to handle subsequent price-matching claims.

In some aspects of an embodiment of the present invention, the one or more details of the price-matching claim include at least one of one or more details about the product, one or more competitors who sell the product, one or more advertisements distributed by the one or more competitors depicting the product, a web address of the one or more advertisements distributed by the one or more competitors depicting the product, a web address of a website of the one or more competitors, a set price at which the one or more competitors are selling the product, an availability of the product sold by the one or more competitors, a period of time during which the product will be sold at the set price, one or more discounts on the product offered by the one or more competitors, and a geo-location of the one or more competitors.

In some aspects of an embodiment of the present invention, a processor applies a series of comparative cognitive techniques to the one or more details of the price-matching claim. A processor validates each detail of the one or more details of the price-matching claim.

In some aspects of an embodiment of the present invention, a processor determines whether the details of the price-matching claim meet the price-matching criteria of the merchant. A processor determines whether the one or more details of the product sold by the merchant match the product sold by the one or more competitors. A processor determines whether the one or more advertisements distributed by the one or more competitors depicts the product. A processor determines whether the one or more advertisements distributed by the one or more competitors is valid during a specified period of time. A processor determines whether the set price at which the one or more competitors are selling the product is valid during the specified period of time. A processor determines whether the product is available for the merchant to sell during the specified period of time.

In some aspects of an embodiment of the present invention, a processor detects whether a fraudulent price-matching activity has occurred to implicate a lower price than a true lowest price.

In some aspects of an embodiment of the present invention, subsequent to detecting the lowest price of the product from the one or more details of the price-matching claim, a processor identifies a seller of the product at the lowest price of the product detected. A processor outputs the price-matching claim to the point-of-sale terminal of the merchant for approval. Responsive to the merchant approving the price-matching claim, a processor generates a form of touchless transfer of data, wherein the form of touchless transfer of data is an on-demand QR code or an NFC tag. A processor outputs the form of touchless transfer of data to the point-of-sale terminal of the merchant to automatically adjust the current price of the merchant to match the price of the competitor.

In some aspects of an embodiment of the present invention, subsequent to detecting the lowest price of the product from the one or more details of the price-matching claim, a processor identifies the seller of the product at the lowest price of the product detected. A processor outputs the price-matching claim to the point-of-sale terminal of the merchant for approval. Responsive to the merchant rejecting the price-matching claim, a processor outputs a rejection to the shopper as an alert notification. A processor enables the shopper to approve the rejection. Responsive to the shopper approving the rejection, a processor completes the transaction on the point-of-sale terminal of the merchant. A processor adds a rejection note to the price-matching claim.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a block diagram illustrating a distributed data processing environment, in accordance with an embodiment of the present invention;

FIG. 2 is a flowchart illustrating the operational steps of a dynamic price-matching program, on a server within the distributed data processing environment of FIG. 1, in accordance with an embodiment of the present invention; and

FIG. 3 is a block diagram illustrating the components of the server within the distributed data processing environment of FIG. 1, in accordance with an embodiment of the present invention.

### DETAILED DESCRIPTION

Embodiments of the present invention recognize that the current process to price-match a product is a manual process that either occurs at the point-of-sale terminal in a brick-and-mortar store or online. At the point-of-sale terminal, a shopper presents a merchant with evidence of a product offered at a lower advertised price by a competitor. The merchant either agrees or disagrees to match the price of the product with the lower advertised price of the competitor.

Embodiments of the present invention recognize that, although the current process may seem simple, it actually presents one or more obstacles for the shopper. A first obstacle is that some merchants have specific requirements that must be met for a product to be price-matched (e.g., the product sold by the competitor must be identical to the product sold by the merchant, the lower advertised price of the competitor must be current, and the competitor must be located within the same city or state as the merchant). Merchants have access to tools to analyze and monitor the competitors' prices. However, this typically occurs at the corporate level, not at the store level. A sales associate of the merchant at the point-of-sale terminal would not have access to that type of information. Therefore, to satisfy the merchant's specific requirements, the shopper may be required to provide the merchant with certain information (e.g., the competitor's current lower advertised price) before the transaction is completed.

Traditionally, the shopper presented the merchant with the competitor's weekly paper flyer. Today, the shopper may use an application on the shopper's mobile phone that aggregates the weekly flyers together based on the shopper's location. The shopper may have to pass the shopper's mobile phone to the merchant so that the merchant can review the competitor's weekly flyer and verify eligibility (e.g., pinch to expand and reveal details of the competitor's weekly flyer, e.g., the competitor's name, the competitor's location, and the details of the product). If the shopper must pass the shopper's mobile phone to the merchant, the shopper runs the risk of microbial transmission. Mobile phones are frequently used, are often in contact with the user's hands and faces, and while in operation, are prone to heating up to temperatures that favor the survival and possible growth of microorganisms. That is combined with the fact that cleaning and disinfecting of mobile phones is not a common practice with up to 72% of mobile phone users never washing their devices. Therefore, mobile phones likely constitute a suitable fomite, meaning an inanimate platform for microbial contamination. In addition to running the risk of microbial transmission, allowing the merchant access to the shopper's phone may compromise the shopper's privacy. For example, there is a chance that, when the merchant is reviewing the weekly flyer on the shopper's phone, the shopper may receive a private pop-up notification that is visible to the merchant, thus compromising the shopper's privacy. A second obstacle is that, in most cases, the current process to price-match a product requires supervisor approval, thus involving more people and prolonging the length of the process.

Therefore, embodiments of the present invention recognize the need to improve the current manual process of price-matching a product at the point-of-sale terminal by enabling a shopper to provide a set of required information directly to the merchant through a dynamic price-matching program for real-time cross-reference verification with an end-result of approval or rejection of the price-matching claim without any manual shopper or merchant interaction.

Embodiments of the present invention provide a system and method to implement a smart real-time price-matching (SRP) tool that automates and improves the process of price-matching a product at the point-of-sale terminal. The SRP tool scans, parses, and analyzes a price matching claim for the product initiated by a shopper at the beginning of a transaction; collects and verifies information and digital facts associated with the product from current price monitoring tools and from other various sources; detects the lowest price of the product; generates an on-demand Quick Response (QR) code, a Near Field Communication (NFC) tag, or another form of a touchless transfer of data to the point-of-sale terminal which will trigger the approval validation process and will automatically adjust the merchant's current price with the price-matched at the point-of-sale terminal; and learns and updates a price of the product in real-time.

Implementation of embodiments of the present invention may take a variety of forms, and exemplary implementation details are discussed subsequently with reference to the Figures.

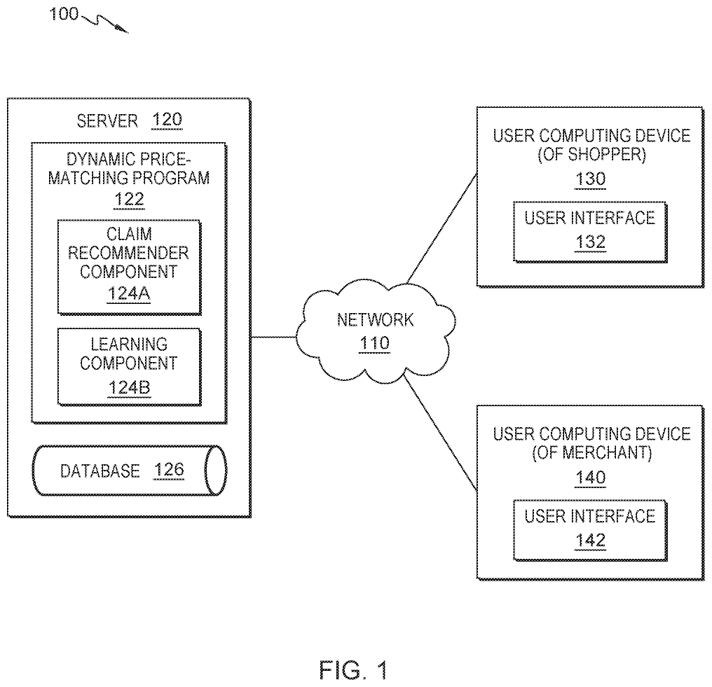

FIG. 1 is a block diagram illustrating a distributed data processing environment, generally designated 100, in accordance with an embodiment of the present invention. In the depicted embodiment, distributed data processing environment 100 includes server 120, user computing device 130 (e.g., of a shopper), and user computing device 140 (e.g., of a merchant), interconnected over network 110. Distributed data processing environment 100 may include additional servers, computers, computing devices, IoT sensors, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing device 130, user computing device 140, and other computing devices (not shown) within distributed data processing environment 100.

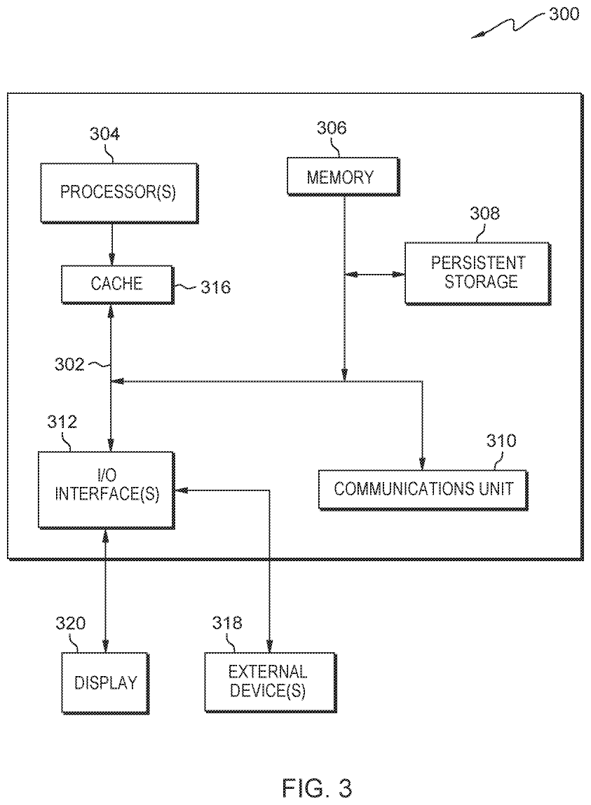

Server 120 operates to run dynamic price-matching program 122 and to send and/or store data in database 126. In an embodiment, server 120 can send data from database 126 to user computing device 130. In another embodiment, server 120 can send data from database 126 to user computing device 140. In an embodiment, server 120 can receive data in database 126 from user computing device 130. In another embodiment, server 120 can receive data in database 126 from user computing device 140. In one or more embodiments, server 120 can be a standalone computing device, a management server, a web server, a mobile computing device, or any other electronic device or computing system capable of receiving, sending, and processing data and capable of communicating with user computing device 130 and user computing device 140 via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130, user computing device 140, and other computing devices (not shown) within distributed data processing environment 100 via network 110. Server 120 may include internal and external hardware components, as depicted and described in further detail in FIG. 3.

Dynamic price-matching program 122 operates to automate and improve the process of price-matching a product at the point-of-sale terminal using a SRP tool. In the depicted embodiment, dynamic price-matching program 122 is a standalone program. In another embodiment, dynamic price-matching program 122 may be integrated into another software product, such as a price comparison software and a point-of-sale software. In the depicted embodiment, dynamic price-matching program 122 resides on server 120. In another embodiment, dynamic price-matching program 122 may reside on user computing device 130, on user computing device 140, or on another computing device (not shown), provided that dynamic price-matching program 122 has access to network 110. In the depicted embodiment, dynamic price-matching program 122 includes claim recommender component 124A and learning component 124B.

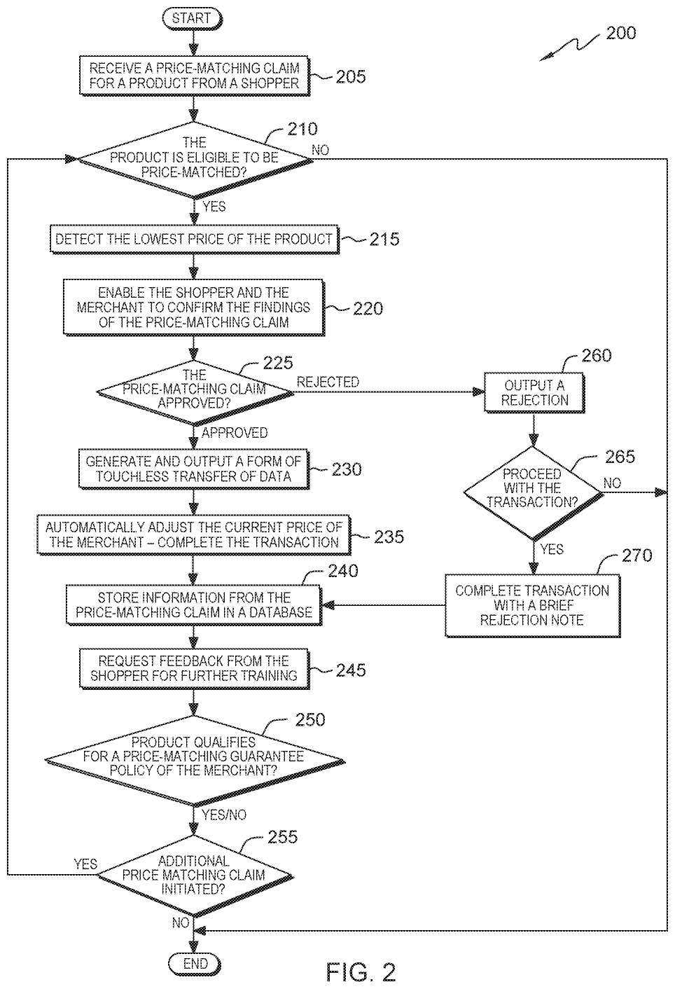

In an embodiment, the user of user computing device 130 and/or the user of user computing device 140 registers with server 120. For example, the user completes a registration process (e.g., user validation), provides information to create a user profile, and authorizes the collection, analysis, and distribution (i.e., opts-in) of relevant data on identified computing devices (e.g., on user computing device 130) by server 120 (e.g., via dynamic price-matching program 122). Relevant data includes, but is not limited to, personal information or data provided by the user or inadvertently provided by the user's device without the user's knowledge; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 126. The operational steps of dynamic price-matching program 122 are depicted and described in further detail with respect to FIG. 2.

Claim recommender component 124A is a built-in feature of dynamic price-matching program 122 that operates to detect the lowest price of a product based on a set of factors. The set of factors may include, but is not limited to, who the one or more competitors are who sell the product, a set price at which the one or more competitors are selling the product (e.g., from an application providing the real-time prices of the one or more competitors), the availability of the product sold by the one or more competitors, a period of time during which the product will be sold at the set price, one or more discounts on the product offered by the one or more competitors, a geo-location of the one or more competitors, and other pre-set user preferences of the user (e.g., free shipping, free setup, free returns). Claim recommender component 124A operates to aggregate a set of user preferences of the user and to correlate the pre-set user preferences of the user with the lowest price of the product detected.

Learning component 124B is a built-in feature of dynamic price-matching program 122 that operates to refine, adjust, and improve dynamic price-matching program 122 so that dynamic price-matching program 122 can handle subsequent price-matching claims similar to the current price-matching claim for the product.

Dynamic price-matching program 122 self-learns by tracking user activity (i.e., by tracking a shopper's activity and a merchant's activity), by classifying and retaining new content, and by improving with each iteration of dynamic price-matching program 122. Dynamic price-matching program 122 tracks previously processed price-matching claims. By tracking the previously processed price-matching claims, dynamic price-matching program 122 can learn which price-matching claims were repeatedly approved and which price-matching claims were repeatedly denied for one or more reasons (e.g., because of one or more attributes of a product or because of one or more target merchants). Dynamic price-matching program 122 can also learn from the previously processed price-matching claims additional information including, but not limited to, one or more major products of the merchant; a pricing strategy and pattern for the one or more major products of the merchant; a set of predefined price-matching policies of the merchant; one or more competitors of a merchant; one or more major products of the one or more competitors of the merchant; and a pricing strategy and pattern of the one or more competitors of the merchant.

Dynamic price-matching program 122 classifies price-matching claims based on the likelihood a price-matching claim will be approved. In an embodiment, dynamic price-matching program 122 classifies the price-matching claim on a scale of 1 (i.e., a low chance the price-matching claim will be approved) to 10 (i.e., a high chance the price-matching claim will be approved). By classifying and retaining such data, dynamic price-matching program 122 can automatically filter out certain price-matching claims over time and ensure that repetitive information is not generated and sent to the user. Instead, dynamic price-matching program 122 bypasses the repetitive information and locates new information for the user. For example, over time, the price of a product will change. Dynamic price-matching program 122 filters out products of previous price-matching claims when the price of the product changes and is no longer within the target price of the shopper.

Dynamic price-matching program 122 can aggregate the success rates of past transactions of a merchant (i.e., the current price of the merchant was automatically adjusted to match the lowest price of the competitor). Dynamic price-matching program 122 can recommend suggestions (e.g., on the likelihood of the approval of certain price-matching claims) to the user (i.e., the shopper and the merchant) based on the success rates of the past transactions of the merchant. Dynamic price-matching program 122 can enable the user to manually filter out price-matching claims. Dynamic price-matching program 122 can enable the user (i.e., a shopper) to customize the profile of the user to select the merchant that meets the user preferences (e.g., free delivery, extended warranty, type of payment accepted, and other commercial transaction attributes) of the user (i.e., the shopper).

Database 126 operates as a repository for data received, used, and/or generated by dynamic price-matching program 122. A database is an organized collection of data. Data includes, but is not limited to, information about user preferences (e.g., general user system settings such as alert notifications for user computing device 130); information about alert notification preferences (e.g., alert notification preview, alert notification style (i.e., alert notification appearing on lock screen, notification center, and/or banner; alert notification appearing temporary or persistently; alert notification sound on or off; alert notification grouping automatically, by application, or off), and alert notification frequency); information about a merchant; one or more major products of the merchant; a pricing strategy and pattern for the one or more major products of the merchant; a set of predefined price-matching policies of the merchant; information about the customers of the merchant (i.e., customer account information (e.g., name of the customer, phone number of the customer, billing/shipping address of the customer, location(s) of the customer, previous purchases of the customer, i.e., a customer's shopping history, an interest in a type of product, one or more selected products, and one or more selected product alert settings that can be connected and disconnected to the network as required)); information about a price-matching claim (i.e., one or more details of a product (i.e., producer of the product, brand name, size, weight, color, quantity, and model number), one or more competitors who sell the product, one or more major products of the one or more competitors, a pricing strategy and pattern of the one or more competitors, one or more advertisements distributed by the one or more competitors depicting the product, a URL (i.e., a web address) to the one or more advertisements distributed by the one or more competitors depicting the product, a URL (i.e., a web address) to a website of the one or more competitors, a set price at which the one or more competitors are selling the product (e.g., from an application providing the real-time prices of the one or more competitors), the availability of the product sold by the one or more competitors, a period of time during which the product will be sold at the set price, one or more discounts on the product offered by the one or more competitors, and a geo-location of the one or more competitors); the result of the price-matching claim; feedback requested from the shopper for further training; and any other data received, used, and/or generated by dynamic price-matching program 122. Selected product alert settings may include, but are not limited to, monitoring a price of the selected product within a specified time period for further price adjustments or warranty expiring alerts.

Database 126 can be implemented with any type of device capable of storing data and configuration files that can be accessed and utilized by server 120, such as a hard disk drive, a database server, or a flash memory. In an embodiment, database 126 is accessed by dynamic price-matching program 122 to store and/or to access the data. In the depicted embodiment, database 126 resides on server 120. In another embodiment, database 126 may reside on another computing device, server, cloud server, or spread across multiple devices elsewhere (not shown) within distributed data processing environment 100, provided that dynamic price-matching program 122 has access to database 126.

The present invention may contain various accessible data sources, such as database 126, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Dynamic price-matching program 122 enables the authorized and secure processing of personal data.

Dynamic price-matching program 122 provides informed consent, with notice of the collection of personal and/or confidential data, allowing the user to opt-in or opt-out of processing personal and/or confidential data. Consent can take several forms. Opt-in consent can impose on the user to take an affirmative action before personal and/or confidential data is processed. Alternatively, opt-out consent can impose on the user to take an affirmative action to prevent the processing of personal and/or confidential data before personal and/or confidential data is processed. Dynamic price-matching program 122 provides information regarding personal and/or confidential data and the nature (e.g., type, scope, purpose, duration, etc.) of the processing. Dynamic price-matching program 122 provides the user with copies of stored personal and/or confidential company data. Dynamic price-matching program 122 allows the correction or completion of incorrect or incomplete personal and/or confidential data. Dynamic price-matching program 122 allows for the immediate deletion of personal and/or confidential data.

User computing device 130 operates to run user interface 132 through which a shopper can interact with dynamic price-matching program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with dynamic price-matching program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132. User computing device 130 may include components as described in further detail in FIG. 3.

User interface 132 operates as a local user interface between dynamic price-matching program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from dynamic price-matching program 122 to a user via network 110. User interface 132 can also display or present alerts including information (such as graphics, text, and/or sound) sent from dynamic price-matching program 122 to a user via network 110. In an embodiment, user interface 132 is capable of sending and receiving data (i.e., to and from dynamic price-matching program 122 via network 110, respectively). Through user interface 132, a user can opt-in to dynamic price-matching program 122; create a user profile; set user preferences and alert notification preferences; initiate a price-matching claim for a product; input details of the price-matching claim for the product; confirm the details of the price-matching claim for the product; confirm the lowest price of the product; receive a rejection; receive a request for feedback on the transaction; and input feedback on the transaction by scoring the transaction.

A user preference is a setting that can be customized for a particular user. A set of default user preferences are assigned to each user of dynamic price-matching program 122. A user preference editor can be used to update values to change the default user preferences. User preferences that can be customized include, but are not limited to, general user system settings, specific user profile settings, alert notification settings, and machine-learned data collection and/or storage settings. Machine-learned data is a user's personalized corpus of data. Machine-learned data includes, but is not limited to, information about a merchant; one or more major products of the merchant; a pricing strategy and pattern for the one or more major products of the merchant; a set of predefined price-matching policies of the merchant; information about the customers of the merchant (i.e., customer account information (e.g., name of the customer, phone number of the customer, billing/shipping address of the customer, location(s) of the customer, previous purchases of the customer, i.e., a customer's shopping history, an interest in a type of product, one or more selected products, and one or more selected product alert settings that can be connected and disconnected to the network as required)); information about a price-matching claim (i.e., one or more details of a product (i.e., producer of the product, brand name, size, weight, color, quantity, and model number), one or more competitors who sell the product, one or more major products of the one or more competitors, a pricing strategy and pattern of the one or more competitors, one or more advertisements distributed by the one or more competitors depicting the product, a URL (i.e., a web address) to the one or more advertisements distributed by the one or more competitors depicting the product, a URL (i.e., a web address) to a website of the one or more competitors, a set price at which the one or more competitors are selling the product (e.g., from an application providing the real-time prices of the one or more competitors), the availability of the product sold by the one or more competitors, a period of time during which the product will be sold at the set price, one or more discounts on the product offered by the one or more competitors, and a geo-location of the one or more competitors); and past results of iterations of price-matching claim.

User computing device 140 operates to run user interface 142 through which a merchant can interact with dynamic price-matching program 122 on server 120. In an embodiment, user computing device 140 is a device that performs programmable instructions. For example, user computing device 140 may be an electronic device, such as a laptop computer, a tablet computer, a netbook computer, a personal computer, a desktop computer, a smart phone, or any programmable electronic device capable of running user interface 142 and of communicating (i.e., sending and receiving data) with dynamic price-matching program 122 via network 110. In general, user computing device 140 represents any programmable electronic device or a combination of programmable electronic devices capable of executing machine readable program instructions and communicating with other computing devices (not shown) within distributed data processing environment 100 via network 110. In the depicted embodiment, user computing device 140 includes an instance of user interface 142. User computing device 140 may include components as described in further detail in FIG. 3.

User interface 142 operates as a local user interface between dynamic price-matching program 122 on server 120 and a user of user computing device 140. In some embodiments, user interface 142 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from dynamic price-matching program 122 to a user via network 110. User interface 142 can also display or present alerts including information (such as graphics, text, and/or sound) sent from dynamic price-matching program 122 to a user via network 110. In an embodiment, user interface 142 is capable of sending and receiving data (i.e., to and from dynamic price-matching program 122 via network 110, respectively). Through user interface 142, a user can opt-in to dynamic price-matching program 122; create a user profile; set user preferences and alert notification preferences; receive an alert notification that a price-matching claim for a product has been initiated; receive the price-matching claim for the product; verify the price-matching claim for the product; and complete the transaction.

FIG. 2 is a flowchart, generally designated 200, illustrating the operational steps of dynamic price-matching program 122, on server 120 within distributed data processing environment 100 of FIG. 1, in accordance with an embodiment of the present invention. In an embodiment, dynamic price-matching program 122 operates to automate and improve the process of price-matching a product at the point-of-sale terminal using a SRP tool. It should be appreciated that the process depicted in FIG. 2 illustrates one possible iteration of the process flow, which may be repeated each time a shopper initiates a price-matching claim for a product.

In step 205, dynamic price-matching program 122 receives a price-matching claim for a product from a shopper. A price-matching claim is a request made by a shopper that a merchant match the price of a product sold by the merchant to the price of the identical product sold by a competitor. The price-matching claim contains one of more details. The one or more details may include, but are not limited to, one or more details of the product (i.e., producer of the product, brand name, size, weight, color, quantity, and model number), one or more competitors who sell the product, one or more advertisements distributed by the one or more competitors depicting the product, a URL (i.e., a web address) to the one or more advertisements distributed by the one or more competitors depicting the product, a URL (i.e., a web address) to a website of the one or more competitors, a set price at which the one or more competitors are selling the product (e.g., from an application providing the real-time prices of the one or more competitors), the availability of the product sold by the one or more competitors, a period of time during which the product will be sold at the set price, one or more discounts on the product offered by the one or more competitors, and a geo-location of the one or more competitors. In an embodiment, dynamic price-matching program 122 receives a price-matching claim for a product from a shopper at the beginning of a transaction at a point-of-sale terminal. A transaction refers to the purchase of goods or services from a merchant by a shopper for the shopper's use. In an embodiment, dynamic price-matching program 122 receives a price-matching claim for a product from a shopper through a defined Application Programming Interface (API) via user interface 132 of user computing device 130. An API is a set of defined rules that explain how computers or applications communicate with one another. An API sits between an application and the web server, acting as an intermediary layer that processes data transfers between systems.

In an embodiment, dynamic price-matching program 122 sends an alert notification to a computing device of a merchant notifying the merchant that a price-matching claim has been initiated. In an embodiment, dynamic price-matching program 122 sends an alert notification to a merchant via user interface 142 of user computing device 140. In an embodiment, dynamic price-matching program 122 pauses the transaction while the price-matching claim is evaluated.

In decision 210, dynamic price-matching program 122 determines whether the product is eligible to be price-matched. In an embodiment, responsive to receiving the price-matching claim for the product from the shopper, dynamic price-matching program 122 determines whether the product is eligible to be price-matched. In an embodiment, dynamic price-matching program 122 determines whether the product is eligible to be price-matched by analyzing the details of the price-matching claim. In an embodiment, dynamic price-matching program 122 analyzes the details of the price-matching claim by applying a series of comparative cognitive techniques to the details of the price-matching claim. In an embodiment, dynamic price-matching program 122 validates the details of the price-matching claim. In an embodiment, dynamic price-matching program 122 validates the details of the price-matching claim by determining whether the details of the price-matching claim meet the price-matching criteria of the merchant. In an embodiment, dynamic price-matching program 122 validates the details of the price-matching claim by determining whether the one or more details of the product (i.e., producer of the product, brand name, size, weight, color, quantity, and model number) sold by the merchant match the product sold by the one or more competitors. In an embodiment, dynamic price-matching program 122 validates the details of the price-matching claim by determining whether the one or more advertisements distributed by the one or more competitors depicts the product. In an embodiment, dynamic price-matching program 122 validates the details of the price-matching claim by determining whether the one or more advertisements distributed by the one or more competitors is valid during a specified period of time. In an embodiment, dynamic price-matching program 122 validates the details of the price-matching claim by determining whether the set price at which the one or more competitors are selling the product is valid during a specified period of time. In an embodiment, dynamic price-matching program 122 validates the details of the price-matching claim by determining whether the product is available for the merchant to sell during the specified period of time.

In another embodiment, dynamic price-matching program 122 determines whether the product is eligible to be price-matched by verifying that a “price-matching” policy does not exclude the product from the price-matching guarantee of the merchant (i.e., a policy to never drop the price of the product). In another embodiment, dynamic price-matching program 122 determines whether the product is eligible to be price-matched by detecting whether fraudulent price-matching activity has occurred to implicate a lower price than the true lowest price.

If dynamic price-matching program 122 determines the product is eligible for price-matching (decision 210, YES branch), dynamic price-matching program 122 proceeds to step 215, detecting the lowest price of the product. If dynamic price-matching program 122 determines the product is not eligible for price-matching (decision 210, NO branch), dynamic price-matching program 122 ends.

In step 215, dynamic price-matching program 122 detects the lowest price of the product. In an embodiment, responsive to determining the product is eligible for price-matching, dynamic price-matching program 122 detects the lowest price of the product. In an embodiment, dynamic price-matching program 122 detects the lowest price of the product using claim recommender component 124A. Claim recommender component 124A detects the lowest price of a product using a set of factors. The set of factors may include, but are not limited to, the one or more details of the price-matching claim (e.g., who the one or more competitors who sell the product are, a set price at which the one or more competitors are selling the product, the availability of the product sold by the one or more competitors, a period of time during which the product will be sold at the set price, one or more discounts on the product offered by the one or more competitors, and a geo-location of the one or more competitors) and other pre-set user preferences of the user. In an embodiment, dynamic price-matching program 122 identifies the final price-match competitor (i.e., the seller of the product at the lowest price detected).

For example, a shopper is looking to purchase product A. Product A is being sold by Merchant X for $49.99 and will be delivered for an additional $25.99. If the shopper returns product A to Merchant X, then the shopper will incur a ten percent (10%) restocking fee. Product A is also being sold by Merchant Y for $64.99 and will be delivered for free. If the shopper returns product A to Merchant Y, the shopper will not incur a restocking fee. Claim recommender component 124A of dynamic price-matching program 122 finds that, after factoring in the additional hidden fees, Merchant Y is offering the lowest price of product A because Merchant Y does not charge a delivery fee or a restocking fee.

In step 220, dynamic price-matching program 122 outputs the findings of the price-matching claim (i.e., the lowest price of the product detected and the seller of the product at the lowest price detected) to the shopper. In an embodiment, responsive to detecting the lowest price of the product, dynamic price-matching program 122 outputs the findings of the price matching claim to the shopper. In an embodiment, dynamic price-matching program 122 outputs the findings of the price-matching claim to the shopper via user interface 132 of user computing device 130. In an embodiment, dynamic price-matching program 122 enables the shopper to confirm the details of the price-matching claim. In an embodiment, dynamic price-matching program 122 enables the shopper to confirm the findings of the price-matching claim. In an embodiment, dynamic price-matching program 122 enables the shopper to confirm the findings of the price-matching claim via user interface 132 of user computing device 130.

In an embodiment, dynamic price-matching program 122 outputs the findings of the price-matching claim to a computing device of the merchant. In an embodiment, dynamic price-matching program 122 outputs the findings of the price-matching claim to the merchant via user interface 142 of user computing device 140. In another embodiment, dynamic price-matching program 122 outputs the findings of the price-matching claim to a computing device of the merchant using Bluetooth. In another embodiment, dynamic price-matching program 122 outputs the findings of the price-matching claim to a computing device of the merchant using an NFC tag. In another embodiment, dynamic price-matching program 122 outputs the findings of the price-matching claim to a computing device of the merchant using another messaging or data transmission method. In an embodiment, dynamic price-matching program 122 enables the merchant to approve the findings of the price-matching claim. In an embodiment, dynamic price-matching program 122 enables the merchant to approve the findings of the price-matching claim via user interface 142 of user computing device 140.

For example, the merchant may reject of the findings of the price-matching claim if the product was not eligible for price-matching because of a price-matching policy of the merchant. In another example, the merchant may reject the findings of the price-matching claim if the product was not eligible for price-matching because one or more details of the product (i.e., producer of the product, brand name, size, weight, color, quantity, and model number) sold by the competitor did not match the one or more details of the product sold by the merchant. In yet another example, the merchant may reject the findings of the price-matching claim if the product was not eligible for price-matching because the set price of the product sold by the competitor is below the price the merchant is willing to match.

In decision 225, dynamic price-matching program 122 determines the state of the price-matching claim. In an embodiment, responsive to outputting the findings of the price matching claim to the shopper, dynamic price-matching program 122 determines the state of the price-matching claim. If the price-matching claim has been approved by the merchant (decision 225, APPROVED branch), then dynamic price-matching program 122 proceeds to step 230, generating a form of touchless transfer of data. If the price-matching claim has not been approved by the merchant (decision 225, REJECTED branch), then dynamic price-matching program 122 proceeds to step 260, outputting a rejection.

In step 230, dynamic price-matching program 122 generates a form of touchless transfer of data. In an embodiment, responsive to determining the price-matching claim has been approved by the merchant, dynamic price-matching program 122 generates a form of touchless transfer of data (e.g., an on-demand QR code or an NFC tag). In an embodiment, dynamic price-matching program 122 generates a form of touchless transfer of data to automatically adjust the current price of the merchant to match the price at which the final price-match competitor is selling the product. In an embodiment, dynamic price-matching program 122 outputs the form of touchless transfer of data to the merchant at the point-of-sale terminal (i.e., via user interface 142 of user computing device 140).

In step 235, dynamic price-matching program 122 automatically adjusts the current price of the merchant. In an embodiment, responsive to generating a form of touchless transfer of data, dynamic price-matching program 122 automatically adjusts the current price of the merchant. In an embodiment, dynamic price-matching program 122 automatically adjusts the current price of the merchant on user computing device 140. In an embodiment, dynamic price-matching program 122 automatically adjusts the current price of the merchant to match the lowest price of the product detected according to a set of predefined price-matching policies.

In an embodiment, dynamic price-matching program 122 enables completion of the transaction using the adjusted price. In an embodiment, dynamic price-matching program 122 enables completion of the transaction using the adjusted price on user computing device 140.

In step 240, dynamic price-matching program 122 stores information from the price-matching claim in a database. In an embodiment, responsive to automatically adjusting the current price of the merchant, dynamic price-matching program 122 stores information from the price-matching claim in a database, e.g., database 126.

In an embodiment, learning component 124B of dynamic price-matching program 122 analyzes the information from the price-matching claim. In an embodiment, learning component 124B of dynamic price-matching program 122 analyzes the information from the price-matching claim to learn whether the product was eligible for price-matching. In an embodiment, learning component 124B of dynamic price-matching program 122 learns whether the product was eligible for price-matching based on one or more current price monitoring tools. In an embodiment, learning component 124B of dynamic price-matching program 122 learns whether the product was eligible for price-matching based on one or more factors. The one or more factors may include, but are not limited to, a price-matching policy of the merchant, one or more details of the product (i.e., producer of the product, brand name, size, weight, color, quantity, and model number), one or more competitors who sells the product, a set price at which the one or more competitors are selling the product, a geo-location of the one or more competitors, and other factors. In an embodiment, learning component 124B of dynamic price-matching program 122 refines, adjusts, and improves dynamic price-matching program 122.

In an embodiment, learning component 124B of dynamic price-matching program 122 learns what are the one or more major products of the merchant. In an embodiment, learning component 124B of dynamic price-matching program 122 learns what is the pricing strategy and pattern of pricing of the one or more major products of the merchant. In an embodiment, learning component 124B of dynamic price-matching program 122 learns what is the predefined price-matching policies of the merchant.

In an embodiment, learning component 124B of dynamic price-matching program 122 learns who are the one or more competitors of the merchant. In an embodiment, learning component 124B of dynamic price-matching program 122 maintains a competitor list of the one or more competitors of the merchant dynamically. In an embodiment, learning component 124B of dynamic price-matching program 122 learns what are the one or more major products of the one or more competitors of the merchant. In an embodiment, learning component 124B of dynamic price-matching program 122 learns what is the pricing strategy and pattern of pricing of the one or more competitors. In an embodiment, learning component 124B of dynamic price-matching program 122 categorizes the one or more major products of the one or more competitors of the merchant and the one or more prices of the one or more major products of the one or more competitors of the merchant.

In step 245, dynamic price-matching program 122 requests feedback from the shopper. In an embodiment, responsive to storing information from the price-matching claim in a database, dynamic price-matching program 122 requests feedback from the shopper for further training. In an embodiment, dynamic price-matching program 122 requests feedback from the shopper via user interface 132 of user computing device 130. In an embodiment, dynamic price-matching program 122 requests feedback from the shopper based on the shopper's success rate (i.e., of price-matching the product identified in the price-matching claim).

In an embodiment, dynamic price-matching program 122 enables the shopper to score the transaction based on the shopper's success rate. For example, scoring 1-10 with 1 being a transaction that was not successful (e.g., the merchant's current price was not adjusted for one or more reasons) and 10 being a transaction that was successful (e.g., the merchant's current price was adjusted to match a competitor's price). In an embodiment, dynamic price-matching program 122 enables the shopper to score the transaction via user interface 132 of user computing device 130.

In an embodiment, dynamic price-matching program 122 receives feedback from the shopper. In an embodiment, learning component 124B of dynamic price-matching program 122 applies the feedback received from the shopper to data stored in the database, i.e., to the current result of an iteration of dynamic price-matching program 122 and to the past results of iterations of dynamic price-matching program 122 stored in the database. In an embodiment, learning component 124B of dynamic price-matching program 122 applies the feedback received from the shopper to data stored in the database to further refine, adjust, and improve the results with each iteration of dynamic price-matching program 122. In an embodiment, learning component 124B of dynamic price-matching program 122 refines, adjusts, and improves dynamic price-matching program 122. In an embodiment, dynamic price-matching program 122 stores feedback from the shopper in a database, e.g., database 126.

In decision 250, dynamic price-matching program 122 determines whether the merchant offers a price-matching guarantee policy for previously purchased products. In an embodiment, responsive to requesting feedback from the shopper for further training, dynamic price-matching program 122 determines whether the merchant offers a price-matching guarantee policy for previously purchased products. A price-matching guarantee policy for previously purchased products is a policy of the merchant to price-match an already purchased product. The merchant price-matches the already purchased product by refunding the shopper the difference between the price the shopper paid and the price for which the competitor is now offering the product. The merchant price-matches already purchased products for a pre-set period of time after the date of purchase.

If dynamic price-matching program 122 determines the merchant does not offer a price-matching guarantee policy for previously purchased products (decision 250, NO branch), then dynamic price-matching program 122 proceeds to decision 255, determining whether the shopper has initiated an additional price-matching claim for a product.

If dynamic price-matching program 122 determines the merchant offers a price-matching guarantee policy for previously purchased products (decision 250, YES branch), then dynamic price-matching program 122 monitors the price of the previously purchased product. In an embodiment, dynamic price-matching program 122 monitors the price of the previously purchased product. In an embodiment, dynamic price-matching program 122 monitors the price of the previously purchased product for a pre-set number of days (i.e., the number of days the merchant offers the price-matching guarantee policy, e.g., thirty (30) days). In an embodiment, dynamic price-matching program 122 monitors the price of the previously purchased product for a change in price to a lower amount of money than the shopper paid.

In an embodiment, responsive to the price of the previously purchased product changing to a lower amount of money than the shopper paid, dynamic price-matching program 122 outputs a message to the shopper as an alert notification. In an embodiment, dynamic price-matching program 122 outputs a message to the shopper via user interface 132 of user computing device 130. In an embodiment, dynamic price-matching program 122 outputs a message to the shopper, notifying the shopper of the price adjustment. In another embodiment, dynamic price-matching program 122 outputs a message to the merchant via user interface 142 of user computing device 140. In an embodiment, dynamic price-matching program 122 outputs a message to the merchant, notifying the merchant of the price adjustment. In an embodiment, dynamic price-matching program 122 enables the merchant to verify the price adjustment. In an embodiment, dynamic price-matching program 122 enables the merchant to automatically refund the shopper the difference between the price the shopper paid and the price for which the competitor is now offering the product on user computing device 140.

In decision 255, dynamic price-matching program 122 determines whether the shopper has initiated an additional price-matching claim. In an embodiment, responsive to requesting feedback from the shopper for further training, dynamic price-matching program 122 determines whether the shopper has initiated an additional price-matching claim. If dynamic price-matching program 122 determines the shopper has initiated an additional price-matching claim (decision 255, YES branch), then dynamic price-matching program 122 returns to decision 210, determining whether the product is eligible to be price-matched. If dynamic price-matching program 122 determines the shopper has not initiated an additional price-matching claim (decision 255, NO branch), then dynamic price-matching program 122 ends.

Returning to decision 225, responsive to the merchant rejecting the price-matching claim, in step 260, dynamic price-matching program 122 outputs a rejection to the shopper. In an embodiment, dynamic price-matching program 122 outputs a rejection to the shopper as an alert notification. In an embodiment, dynamic price-matching program 122 outputs a rejection to the shopper via user interface 132 of user computing device 130.

In decision 265, dynamic price-matching program 122 determines whether the shopper will proceed with the transaction. In an embodiment, responsive to outputting a rejection to the shopper, dynamic price-matching program 122 determines whether the shopper will proceed with the transaction. In an embodiment, dynamic price-matching program 122 enables the shopper to approve the rejection and complete the transaction via user interface 132 of user computing device 130. If the shopper approves the rejection and wishes to complete the transaction (decision 265, YES branch), then dynamic price-matching program 122 proceeds to step 270, completing the transaction. If the user disapproves of the rejection and wishes not to complete the transaction (decision 265, NO branch), then dynamic price-matching program 122 ends.

In step 270, dynamic price-matching program 122 completes the transaction. In an embodiment, responsive to the shopper determining to proceed with the transaction, dynamic price-matching program 122 completes the transaction. In an embodiment, dynamic price-matching program 122 completes the transaction on user computing device 140. In an embodiment, dynamic price-matching program 122 adds a brief rejection note to the price-matching claim for the product.

For example, shopper B is looking to purchase a certain model of a TV. Shopper B has done her homework and found the lowest price of the TV in the market at electronic store C. Electronic store C, however, does not have the TV in stock, but electronic store D does. Electronic store D also promises to price-match a product with an identical product from a competitor. Shopper B is at electronic store D looking to buy the TV at the price-matched price. Shopper B uses user interface 132 of user computing device 130 to generate a price-matching claim for the TV. Shopper B transmits the price-matching claim to the point-of-sale terminal at the beginning of the transaction through a dynamic link. Shopper B's price-matching claim is validated and the price of the TV is automatically adjusted at the register.

In another example, shopper E is looking to purchase a tablet at electronic store F. However, electronic store G sells the same tablet for $75 less. Shopper E uses user interface 132 of user computing device 130 to generate a price-matching claim for the tablet. Shopper B transmits the price-matching claim to the point-of-sale terminal at the beginning of the transaction through a dynamic link. His request has placed the order on hold for a few seconds while dynamic price-matching program 122 receives and evaluates the claim. The associate of electronic store F is prompted with a message stating that a price-matching request is in progress. Dynamic price-matching program 122 automatically adjusts the price without any manual interaction from the associate or a supervisor of the associate. Dynamic price-matching program 122 learns this new request and stores it for future reference.

In yet another example, shopper H is looking to purchase a printer. Shopper H finds a printer on sale at big box store I. Shopper H finds the same printer on sale at big box store J for a better price. Shopper H takes the printer to the self-checkout counter with no assistance from an associate. Shopper H uses user interface 132 of user computing device 130 to generate a price-matching claim for the printer. Shopper B transmits the price-matching claim to the point-of-sale terminal at the beginning of the transaction through a dynamic link. His transaction is placed on hold for a few seconds while dynamic price-matching program 122 receives and evaluates the price-matching claim. Dynamic price-matching program 122 sends a message to the point-of-sale terminal, alerting the point-of-sale terminal a price-matching claim is in progress. Dynamic price-matching program 122 automatically adjusts the price without any manual interaction from the associate or a supervisor of the associate. Shopper H completes the transaction by paying for the printer at the price-matched price.

FIG. 3 is a block diagram illustrating the components of computing device 300 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made. Computing device 300 includes processor(s) 304, memory 306, cache 316, communications fabric 302, persistent storage 308, input/output (I/O) interface(s) 312, and communications unit 310. Communications fabric 302 provides communications between memory 306, cache 316, persistent storage 308, input/output (I/O) interface(s) 312, and communications unit 310. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses or a cross switch. Memory 306 and persistent storage 308 are computer readable storage media. In this embodiment, memory 306 includes random access memory (RAM). In general, memory 306 can include any suitable volatile or non-volatile computer readable storage media. Cache 316 is a fast memory that enhances the performance of computer processor(s) 304 by holding recently accessed data, and data near accessed data, from memory 306.

Program instructions and data (e.g., software and data 314) used to practice embodiments of the present invention may be stored in persistent storage 308 and in memory 306 for execution by one or more of the respective processor(s) 304 via cache 316. In an embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308. Software and data 314 can be stored in persistent storage 308 for access and/or execution by one or more of the respective processor(s) 304 via cache 316. With respect to user computing device 130, software and data 314 includes user interface 132. With respect to server 120, software and data 314 includes dynamic price-matching program 122.

Communications unit 310, in these examples, provides for communications with other data processing systems or devices. In these examples, communications unit 310 includes one or more network interface cards. Communications unit 310 may provide communications through the use of either or both physical and wireless communications links. Program instructions and data (e.g., software and data 314) used to practice embodiments of the present invention may be downloaded to persistent storage 308 through communications unit 310.

I/O interface(s) 312 allows for input and output of data with other devices that may be connected to each computer system. For example, I/O interface(s) 312 may provide a connection to external device(s) 318, such as a keyboard, a keypad, a touch screen, and/or some other suitable input device. External device(s) 318 can also include portable computer readable storage media, such as, for example, thumb drives, portable optical or magnetic disks, and memory cards. Program instructions and data (e.g., software and data 314) used to practice embodiments of the present invention can be stored on such portable computer readable storage media and can be loaded onto persistent storage 308 via I/O interface(s) 312. I/O interface(s) 312 also connect to display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

While particular embodiments of the present invention have been shown and described here, it will be understood to those skilled in the art that, based upon the teachings herein, changes and modifications may be made without departing from the embodiments and its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understand, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to embodiments containing only one such element, even when the same claim includes the introductory phrases “at least one” or “one or more” and indefinite articles such as “a” or “an”, the same holds true for the use in the claims of definite articles.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart illustrations and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the Figures illustrate the architecture, functionality, and operation of possible implementations of systems, methods, and computer program products according to various embodiments of the present invention. In this regard, each block in the flowchart illustrations or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each flowchart illustration and/or block of the block diagrams, and combinations of flowchart illustration and/or blocks in the block diagrams, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving, by one or more processors, a price-matching claim for a product from a shopper;
determining, by the one or more processors, whether the product is eligible to be price-matched by analyzing one or more details of the price-matching claim;
responsive to determining the product is eligible to be price-matched, detecting, by the one or more processors, a lowest price of the product from the one or more details of the price-matching claim; and
automatically adjusting, by the one or more processors, a current price of the product to match the lowest price of the product detected at a point-of-sale terminal of a merchant according to a set of pre-defined price-matching policies.

2. The computer-implemented method of claim 1, further comprising:
subsequent to automatically adjusting the current price of the product to match the lowest price of the product detected at the point-of-sale terminal of the merchant, completing, by the one or more processors, a transaction on the point-of-sale terminal of the merchant that includes the product; and
updating, by the one or more processors, a learning module to handle subsequent price-matching claims.

3. The computer-implemented method of claim 1, wherein the one or more details of the price-matching claim include at least one of one or more details about the product, one or more competitors who sell the product, one or more advertisements distributed by the one or more competitors depicting the product, a web address of the one or more advertisements distributed by the one or more competitors depicting the product, a web address of a website of the one or more competitors, a set price at which the one or more competitors are selling the product, an availability of the product sold by the one or more competitors, a period of time during which the product will be sold at the set price, one or more discounts on the product offered by the one or more competitors, and a geo-location of the one or more competitors.

4. The computer-implemented method of claim 3, wherein determining whether the product is eligible to be price-matched by analyzing the one or more details of the price-matching claim further comprises:
applying, by the one or more processors, a series of comparative cognitive techniques to the one or more details of the price-matching claim; and
validating, by the one or more processors, each detail of the one or more details of the price-matching claim.

5. The computer implemented method of claim 4, wherein validating each detail of the one or more details of the price-matching claim further comprises:
determining, by the one or more processors, whether the details of the price-matching claim meet the price-matching criteria of the merchant;
determining, by the one or more processors, whether the one or more details of the product sold by the merchant match the product sold by the one or more competitors;
determining, by the one or more processors, whether the one or more advertisements distributed by the one or more competitors depicts the product;
determining, by the one or more processors, whether the one or more advertisements distributed by the one or more competitors is valid during a specified period of time;
determining, by the one or more processors, whether the set price at which the one or more competitors are selling the product is valid during the specified period of time; and
determining, by the one or more processors, whether the product is available for the merchant to sell during the specified period of time.

6. The computer-implemented method of claim 1, wherein determining whether the product is eligible to be price-matched by analyzing the one or more details of the price-matching claim further comprises:
detecting, by the one or more processors, whether a fraudulent price-matching activity has occurred to implicate a lower price than a true lowest price.

7. The computer-implemented method of claim 1, further comprising:
subsequent to detecting the lowest price of the product from the one or more details of the price-matching claim, identifying, by the one or more processors, a seller of the product at the lowest price of the product detected;
outputting, by the one or more processors, the price-matching claim to the point-of-sale terminal of the merchant for approval;
responsive to the merchant approving the price-matching claim, generating, by the one or more processors, a form of touchless transfer of data, wherein the form of touchless transfer of data is an on-demand QR code or an NFC tag; and
outputting, by the one or more processors, the form of touchless transfer of data to the point-of-sale terminal of the merchant to automatically adjust the current price of the merchant to match the price of the competitor.

8. The computer-implemented method of claim 1, further comprising:
subsequent to detecting the lowest price of the product from the one or more details of the price-matching claim, identifying, by the one or more processors, the seller of the product at the lowest price of the product detected;
outputting, by the one or more processors, the price-matching claim to the point-of-sale terminal of the merchant for approval;
responsive to the merchant rejecting the price-matching claim, outputting, by the one or more processors, a rejection to the shopper as an alert notification;
enabling, by the one or more processors, the shopper to approve the rejection;
responsive to the shopper approving the rejection, completing, by the one or more processors, the transaction on the point-of-sale terminal of the merchant; and
adding, by the one or more processors, a rejection note to the price-matching claim.

9. A computer program product comprising:
one or more computer readable storage media and program instructions stored on the one or more computer readable storage media, the program instructions comprising:
program instructions to receive a price-matching claim for a product from a shopper;
program instructions to determine whether the product is eligible to be price-matched by analyzing one or more details of the price-matching claim;
responsive to determining the product is eligible to be price-matched, program instructions to detect a lowest price of the product from the one or more details of the price-matching claim; and
program instructions to automatically adjust a current price of the product to match the lowest price of the product detected at a point-of-sale terminal of a merchant according to a set of pre-defined price-matching policies.

10. The computer program product of claim 9, further comprising:
subsequent to automatically adjusting the current price of the product to match the lowest price of the product detected at the point-of-sale terminal of the merchant, program instructions to complete a transaction on the point-of-sale terminal of the merchant that includes the product; and
program instructions to update a learning module to handle subsequent price-matching claims.

11. The computer program product of claim 9, wherein the one or more details of the price-matching claim include at least one of one or more details about the product, one or more competitors who sell the product, one or more advertisements distributed by the one or more competitors depicting the product, a web address of the one or more advertisements distributed by the one or more competitors depicting the product, a web address of a website of the one or more competitors, a set price at which the one or more competitors are selling the product, an availability of the product sold by the one or more competitors, a period of time during which the product will be sold at the set price, one or more discounts on the product offered by the one or more competitors, and a geo-location of the one or more competitors.

12. The computer program product of claim 11, wherein determining whether the product is eligible to be price-matched by analyzing the one or more details of the price-matching claim further comprises:
program instructions to apply a series of comparative cognitive techniques to the one or more details of the price-matching claim; and
program instructions to validate each detail of the one or more details of the price-matching claim.

13. The computer program product of claim 9, further comprising:
subsequent to detecting the lowest price of the product from the one or more details of the price-matching claim, program instructions to identify a seller of the product at the lowest price of the product detected;
program instructions to output the price-matching claim to the point-of-sale terminal of the merchant for approval;
responsive to the merchant approving the price-matching claim, program instructions to generate a form of touchless transfer of data, wherein the form of touchless transfer of data is an on-demand QR code or an NFC tag; and
program instructions to output the form of touchless transfer of data to the point-of-sale terminal of the merchant to automatically adjust the current price of the merchant to match the price of the competitor.

14. The computer program product of claim 9, further comprising:
subsequent to detecting the lowest price of the product from the one or more details of the price-matching claim, program instructions to identify the seller of the product at the lowest price of the product detected;
program instructions to output the price-matching claim to the point-of-sale terminal of the merchant for approval;
responsive to the merchant rejecting the price-matching claim, program instructions to output a rejection to the shopper as an alert notification;
program instructions to enable the shopper to approve the rejection;
responsive to the shopper approving the rejection, program instructions to complete the transaction on the point-of-sale terminal of the merchant; and
program instructions to add a rejection note to the price-matching claim.

15. A computer system comprising:
one or more computer processors;
one or more computer readable storage media;
program instructions collectively stored on the one or more computer readable storage media for execution by at least one of the one or more computer processors, the stored program instructions comprising:
program instructions to receive a price-matching claim for a product from a shopper;
program instructions to determine whether the product is eligible to be price-matched by analyzing one or more details of the price-matching claim;
responsive to determining the product is eligible to be price-matched, program instructions to detect a lowest price of the product from the one or more details of the price-matching claim; and
program instructions to automatically adjust a current price of the product to match the lowest price of the product detected at a point-of-sale terminal of a merchant according to a set of pre-defined price-matching policies.

16. The computer system of claim 15, further comprising:
subsequent to automatically adjusting the current price of the product to match the lowest price of the product detected at the point-of-sale terminal of the merchant, program instructions to complete a transaction on the point-of-sale terminal of the merchant that includes the product; and
program instructions to update a learning module to handle subsequent price-matching claims.

17. The computer system of claim 15, wherein the one or more details of the price-matching claim include at least one of one or more details about the product, one or more competitors who sell the product, one or more advertisements distributed by the one or more competitors depicting the product, a web address of the one or more advertisements distributed by the one or more competitors depicting the product, a web address of a website of the one or more competitors, a set price at which the one or more competitors are selling the product, an availability of the product sold by the one or more competitors, a period of time during which the product will be sold at the set price, one or more discounts on the product offered by the one or more competitors, and a geo-location of the one or more competitors.

18. The computer system of claim 17, wherein determining whether the product is eligible to be price-matched by analyzing the one or more details of the price-matching claim further comprises:
program instructions to apply a series of comparative cognitive techniques to the one or more details of the price-matching claim; and
program instructions to validate each detail of the one or more details of the price-matching claim.

19. The computer system of claim 15, further comprising:
subsequent to detecting the lowest price of the product from the one or more details of the price-matching claim, program instructions to identify a seller of the product at the lowest price of the product detected;
program instructions to output the price-matching claim to the point-of-sale terminal of the merchant for approval;
responsive to the merchant approving the price-matching claim, program instructions to generate a form of touchless transfer of data, wherein the form of touchless transfer of data is an on-demand QR code or an NFC tag; and
program instructions to output the form of touchless transfer of data to the point-of-sale terminal of the merchant to automatically adjust the current price of the merchant to match the price of the competitor.

20. The computer system of claim 15, further comprising:
subsequent to detecting the lowest price of the product from the one or more details of the price-matching claim, program instructions to identify the seller of the product at the lowest price of the product detected;
program instructions to output the price-matching claim to the point-of-sale terminal of the merchant for approval;
responsive to the merchant rejecting the price-matching claim, program instructions to output a rejection to the shopper as an alert notification;
program instructions to enable the shopper to approve the rejection;
responsive to the shopper approving the rejection, program instructions to complete the transaction on the point-of-sale terminal of the merchant; and
program instructions to add a rejection note to the price-matching claim.
